(19) United States
(12) Patent Application Publication
(10) Pub. No.: US 2017/0023529 A1
(43) Pub. Date: Jan. 26, 2017

(54) SYSTEM AND METHOD FOR TAKING A MEASUREMENT AT A CONNECTION ELEMENT

(71) Applicant: Airbus Operations GmbH, Hamburg (DE)

(72) Inventors: Joern Skirke, Hamburg (DE); Guenter Schlueter, Hamburg (DE)

(21) Appl. No.: 15/215,338

(22) Filed: Jul. 20, 2016

(30) Foreign Application Priority Data
Jul. 21, 2015 (DE) 102015111826.2

(51) Int. Cl. G01N 29/07; G01N 29/22

(52) U.S. Cl. CPC G01N 29/07; G01N 29/223; G01N 2291/2694; G01N 2291/011

(57) ABSTRACT

A system for taking a measurement at a connection element protruding from a specified surface. The system has an ultrasonic sensor and a positioning bushing. The positioning bushing has a first recess and a second recess. The first recess is configured to receive the ultrasonic sensor, at least in part. The second recess is configured to receive at least part of the connection element protruding from the surface. The positioning bushing is configured to orientate the ultrasonic sensor relative to the connection element in a specified manner.

### CROSS-REFERENCES TO RELATED APPLICATIONS

This application claims the benefit of the German patent application No102015111826.2 filed on Jul. 21, 2015, the entire disclosures of which are incorporated herein by way of reference.

### FIELD OF THE INVENTION

The invention relates to a system and a method for taking a measurement at a connection element.

### BACKGROUND OF THE INVENTION

Structural components of an aircraft, in particular shell-like structural components, are nowadays connected to one another by connection elements, such as rivets. By way of example, shell-like segments of the aircraft outer skin are connected to one another by a multiplicity of rivets, which are exposed to high loads during the operation of the aircraft. These loads are often not only of a mechanical nature, but are also of a thermal nature, and are produced by the occurrence of high temperature differences between ground operation and flight operation of the aircraft. The rivet connections are checked at certain intervals, accordingly.

DE 10 2010 013 515 B4 describes a drilling and riveting device and also a riveting method for connecting two or more components in aircraft manufacturing structural assembly.

DE 10 2012 202 242 A1 describes a method for joining molded parts by means of a punch rivet, wherein, in one step, a punched hole is radially widened in one section.

### SUMMARY OF THE INVENTION

An object of the invention is to enable a reliable and most accurately possible measurement of connection elements.

The invention is characterized in accordance with a first aspect by a system for taking a measurement at a connection element, which is already acted on by a preload and protrudes from a specified surface. The system has an ultrasonic sensor and a positioning bushing. The positioning bushing has a first recess and a second recess. The first recess is designed to receive the ultrasonic sensor at least in part. The second recess is designed to receive at least the part of the connection element protruding from the surface. The positioning bushing is designed to orientate the ultrasonic sensor relative to the connection element in a specified manner

The system is preferably used to measure connection elements that have already been installed. In the installed state, the connection element is already acted on by a preload. The system is thus suitable for measuring connection elements once these have been installed as intended. The system preferably is not used to measure the connection element during the installation.

This has the advantage that the ultrasonic sensor can be oriented substantially in an ideal manner relative to the connection element to be measured. In particular, this is then advantageous, when the system is manually operated, in order to take a measurement of a plurality of connection elements on the surface in a reliable and accurate manner.

The positioning bushing is preferably designed to orientate the ultrasonic sensor relative to the connection element and relative to the surface in a specified manner

Here, the positioning bushing is produced in such a way that the first recess and the second recess are oriented relative to one another in such a way that the necessary orientation of the ultrasonic sensor relative to the connection element is achieved, in order to enable a reliable measurement of the connection element. A specified ultrasonic signal is preferably fed into the connection element by means of the ultrasonic sensor and is reflected at an end of the connection element opposite the feed. The reflected signal is then preferably detected by the ultrasonic sensor. The reflecting end of the connection element can be flat or can have one or more known irregularities. The orientation of the ultrasonic sensor, by means of the first and second recesses of the system, is then specified in such a way that the ultrasonic signal contacts a region of the reflecting end enabling a reliable reflection. The connection element can thus be reliably measured.

The connection element can be formed, for example, as a rivet or screw rivet. The connection element can, alternatively, also be formed as a screw connection or as a retaining ring bolt (lockbolt). Connection elements that can be measured are preferably those that, in the installed state, are acted on by a preload.

A propagation time of the fed and reflected ultrasonic signal in the installed connection element can preferably be ascertained by means of an evaluation unit, which is electrically coupled to the ultrasonic sensor. Depending on this, a length of the connection element and, in turn depending thereon, a level of a preload of the connection element in the installed state, can then be ascertained.

The first recess in the positioning bushing is formed here in such a way that it has a substantially identical diameter to the ultrasonic sensor and can thus receive the ultrasonic sensor exactly. The diameter of the second recess is substantially identical to an outer diameter of the connection element, such that the positioning bushing can be placed over this part of the connection element protruding from the surface. Here, the ultrasonic sensor is arranged axially in the positioning bushing in such a way that the sensor head of the ultrasonic sensor is in contact with the part of the connection element. The sensor head is typically also in contact with the part of the connection element by means of a coupling medium, for example a gel material, oil or water, in order to enable a reliable feed of the specified ultrasonic signal and/or in order to reliably detect the reflected signal component.

In an advantageous embodiment of the first aspect, the ultrasonic sensor is arranged in an axially displaceable manner in the first recess in the positioning bushing. In other words, the ultrasonic sensor, once placed over the positioning bushing, can still be displaced axially over the connection element to be measured, until the ultrasonic sensor is in contact with the connection element. A reliable measurement of the connection element can thus be made possible.

In a further advantageous embodiment of the first aspect, the positioning bushing comprises at least one ventilation opening, which creates a connection between a space, which is formed during a measurement in the region of the sensor head of the ultrasonic sensor and the connection element, and a surrounding environment. As the positioning bushing is placed over the connection element and/or as the ultrasonic sensor is axially displaced in the direction of the connection element to be measured, excess air in the resultant space can thus escape, such that the sensor head can be reliably brought into contact with the connection element.

The ventilation device is arranged, for example, as a hole in the positioning bushing, level with the space created during the measurement in the region of the sensor head and the protruding part of the connection element. Alternatively, the ventilation device can be formed as a channel of specified size, which extends along the first recess along the longitudinal direction in the positioning bushing and couples the space and the surrounding environment to one another.

In a further advantageous embodiment of the first aspect, the system comprises a guide bushing, which is arranged separately to the positioning bushing and is mechanically coupled to the ultrasonic sensor. The guide bushing has a grip region, by means of which the system can be manually guided. This has the advantage that the ultrasonic sensor can be reliably guided manually by means of the guide bushing over one or more connection elements to be measured.

The mechanical coupling in this context preferably means that the ultrasonic sensor is mechanically coupled to the guide bushing in such a way that the guide bushing is in contact with the ultrasonic sensor.

In a further advantageous embodiment of the first aspect, the guide bushing is arranged on an end of the ultrasonic sensor opposite the sensor head. Here, the guide bushing is preferably formed separately from the positioning bushing and preferably receives the part of the ultrasonic sensor opposite the sensor head. In order to receive this part, the guide bushing has a third recess, of which the inner diameter is substantially identical to the outer diameter of the part of the ultrasonic sensor to be received. Furthermore, the guide bushing preferably has a feedthrough, through which a cable can be guided, in order to electrically couple the ultrasonic sensor to the evaluation unit.

In a further advantageous embodiment of the first aspect, the guide bushing is mechanically coupled to the ultrasonic sensor by means of a fixing device. This enables a secure manual guidance of the ultrasonic sensor. In a further advantageous embodiment of the first aspect, the positioning bushing comprises at least one spring device, which acts on the ultrasonic sensor in the direction of the connection element during a measurement. This has the advantage that the sensor head of the ultrasonic sensor is pressed by means of the spring device onto the connection element to be measured and thus can be reliably measured. Here, the spring device can be arranged in the second recess as a compression spring, for example as a helical spring, and can be supported on a first spring side on the positioning bushing and can act via a second spring side on the sensor head of the ultrasonic sensor. The first spring side is preferably mechanically coupled to the positioning bushing, and the second spring side is preferably mechanically coupled to the sensor head, such that the ultrasonic sensor cannot be lost as soon as the positioning bushing is lifted from the surface. Other embodiments of the spring device are also conceivable. For this purpose, the ultrasonic sensor is typically arranged in an axially displaceable manner in the first recess in the positioning bushing. In addition, the guide bushing can also be fixed on the ultrasonic sensor in such a way that, when the spring device acts on the ultrasonic sensor, the ultrasonic sensor cannot be pushed out from the second recess. The guide bushing is then in contact with the positioning bushing and thus blocks a further axial displacement of the ultrasonic sensor. Due to the corresponding fixing of the guide bushing on the ultrasonic sensor, a maximum axial movement of the ultrasonic sensor can thus be specified.

In a further advantageous embodiment of the first aspect, the positioning bushing is made of a material that has a lower degree of hardness than a material from which the connection element to be measured is made.

The positioning bushing is furthermore preferably made of plastic.

This means that the positioning bushing is made of a material that is softer than a material from which the connection element to be measured is made. Alternatively, or additionally, the positioning bushing can also be made of a metal that is softer than the material from which the connection element is made. The positioning bushing of the system is therefore suitable for measuring connection elements once these have been installed as intended. The positioning bushing of the system therefore is not used to secure the connection element or to act on the connection element with a preload. The system therefore is not suitable for measuring the connection element as this is being installed.

The invention is characterized, in accordance with the second aspect, by a method for measuring a connection element by means of the system according to the first aspect, in which method the connection element is secured and is acted on by a preload. The ultrasonic sensor is then oriented relative to the connection element and the surface by means of the second recess in the positioning bushing. The second recess is then placed over the protruding part of the connection element. The connection element is then measured.

In the installed state, the connection element is already acted on by a preload. The method is therefore suitable particularly for measuring connection elements already installed as intended and acted on by a preload. By means of the method, it is thus preferably ascertained whether the connection elements are actually secured with a specified target preload.

### BRIEF DESCRIPTION OF THE DRAWINGS

The above-described aspects and further aspects, features and advantages of the invention can also be deduced from the examples of the embodiments, which will be described hereinafter with reference to the accompanying drawings.

FIG. 1 shows a system having a connection element protruding from a surface,

FIGS. 2a and 2b shows sections through a system,

FIG. 3 shows a longitudinal section through a system,

FIG. 4 shows a method for taking a measurement.

### DETAILED DESCRIPTION OF THE PREFERRED EMBODIMENTS

In the figures, like reference signs are used for like or at least similar elements, components or aspects. It is noted that embodiments that are merely illustrative and that are not limiting are described in detail hereinafter.

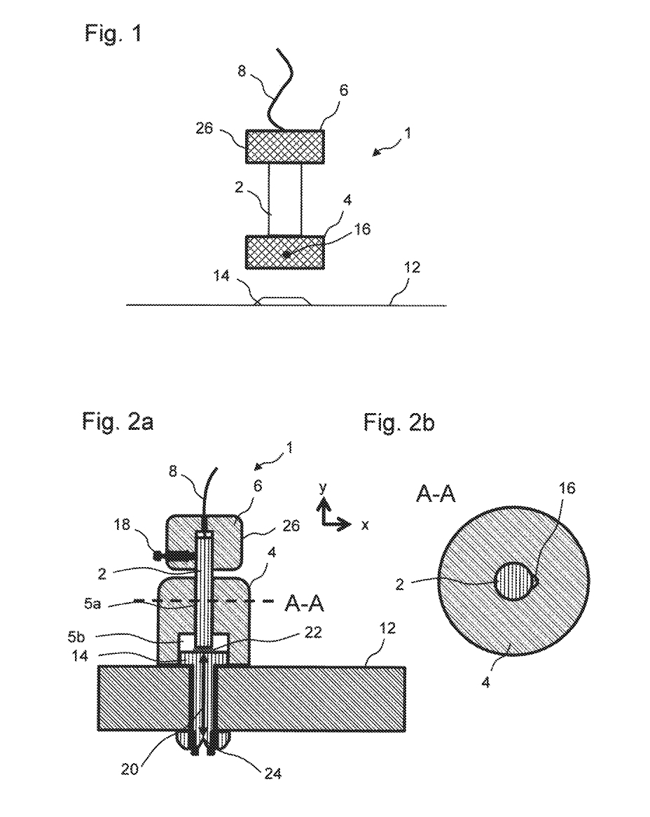

In FIG. 1, a measurement system, also referred to hereinafter as the system 1, is illustrated. This comprises an ultrasonic sensor 2 and a positioning bushing 4. The positioning bushing 4 is arranged in the region of a sensor head of the ultrasonic sensor 2 and receives, in this region, the ultrasonic sensor 2. The ultrasonic sensor 2 is typically electrically coupled by means of a cable 8 to an evaluation unit (not illustrated).

Besides the positioning bushing 4, the system 1 can also comprise a guide bushing 6. This is assigned to an end of the ultrasonic sensor 2 opposite the sensor head. In this region, the guide bushing 6 receives the ultrasonic sensor 2.

A measurement of a connection element 14 can be taken, provided the positioning bushing 4 is placed over the connection element 14 in such a way that the positioning bushing 4 is in contact with the surface 12, from which part of the connection element 14 protrudes. Here, the connection element 14 is already preferably installed as intended and thus acted on by a preload.

In FIG. 2a a longitudinal section of the system 1 and of the connection element 14 is illustrated. The connection element 14 is formed, for example, as a screw rivet. The positioning bushing 4 is placed over an upper, protruding part of the connection element 14, more specifically in such a way that the positioning bushing is in contact with the surface 12.

The positioning bushing 4 has a first recess 5a and a second recess 5b. The first recess 5a is arranged in FIG. 2a in the upper region of the positioning bushing 4. The first recess 5a has an inner diameter that is substantially identical to an outer diameter of the ultrasonic sensor 2 in this region. The positioning bushing 4 is thus designed, in this region, to receive the ultrasonic sensor 2, at least in part.

The second recess 5b is formed in FIG. 2a in the positioning bushing 4 in the lower region, in such a way that the ultrasonic sensor 2 protrudes, at least via its sensor head, into the recess. An inner diameter of the second recess 5b is substantially identical to an outer diameter of the part of the connection element 14 to be covered during the measurement. In FIG. 2a the second recess 5b receives the part of the connection element 14 protruding from the surface 12, such that the sensor head of the ultrasonic sensor 2 is in contact with this part of the connection element 14. The ultrasonic sensor 2 is thus arranged axially, i.e., in the y-direction, in the positioning bushing 4 in such a way that the sensor head of the ultrasonic sensor is in contact with the part of the connection element 14. A coupling medium 22, for example a gel material, oil or water, is typically arranged between the part of the connection element 14 and the sensor head. Alternatively, the ultrasonic sensor 2 can also be arranged in an axially displaceable manner in the first recess 5a. The first recess 5a prevents a displacement of the ultrasonic sensor 2 in the x-direction.

The system 1 also comprises a guide bushing 6, which is arranged separately to the positioning bushing 4 and is mechanically coupled to the ultrasonic sensor 2. The guide bushing 6 is preferably associated with the end of the ultrasonic sensor 2, the positioning bushing 4 being in contact with the end of the ultrasonic sensor 2. This end of the ultrasonic sensor 2 is opposite the sensor head of the sensor. In order to receive this part, the guide bushing 6 has a third recess, of which the inner diameter is substantially identical to an outer diameter of the part of the ultrasonic sensor 2 to be received. The guide bushing 6 preferably has a feedthrough, through which a cable 8 can be guided in order to electrically couple the ultrasonic sensor 2 to an evaluation unit.

The positioning bushing 4 is produced in such a way that the first recess 5a and the second recess 5b are oriented relative to one another in the x-direction in such a way that a reliable measurement of the connection element 14 is made possible. By way of example, within the scope of what is known as a pulse-echo process, a specified ultrasonic signal 20 is fed into the connection element 14 by means of the ultrasonic sensor 2. For this purpose, the positioning bushing 4 together with the ultrasonic sensor 2 is placed over the protruding part of the connection element 14 in the surface 12, such that the specified ultrasonic signal 20 can be fed into the connection element 14 by means of the sensor head. The specified ultrasonic signal 20 is reflected in the connection element 14 at an end opposite the feed. Here, the reflecting end of the connection element 14 can be flat or can have one or more known irregularities. The orientation of the ultrasonic sensor 2 by means of the first and second recess 5a, 5b of the system 1 in the x-direction is specified in such a way that the ultrasonic signal 20 is reliably reflected, even if there are irregularities.

By means of the ultrasonic sensor 2, the reflected ultrasonic signal 20 can preferably also be detected. A propagation time of the signal through the connection element 14 and, depending thereon, a length of the connection element 14 can be ascertained from a difference between the time of feed and the time of receipt of the ultrasonic signal 20. Depending on this, a level of a preload of the connection element 14 in the installed state can be ascertained in turn. This is ascertained preferably by the evaluation unit electrically coupled to the ultrasonic sensor 2.

The guide bushing 6 can additionally comprise a fixing device 18, by means of which the ultrasonic sensor 2 can be mechanically coupled to the guide bushing 6. The fixing device 18 is embodied, for example, as one or more screws, which each bite into a thread, the threads being formed in the guide bushing 6. Here, the screw in question is screwed into the assigned thread in such a way that the screw is coupled in a frictionally engaged manner to the ultrasonic sensor 2. Alternatively, the fixing device 6 can also be formed as a snap-fit device or as another mechanism known to a person skilled in the art, in order to mechanically couple the ultrasonic sensor 2 to the guide bushing 6.

Both the positioning bushing 4 and the guide bushing 6 can be produced from a plastic. The positioning bushing 4 and/or the guide bushing 6 can also comprise metal. The system is thus suitable for measuring connection elements once these have been installed as intended. The guide bushing 6 also preferably has a specified fluting in a grip region 26, which enables a particularly secure manual handling of the system 1.

In FIG. 2b a cross section of the positioning bushing 4 along the line of section A-A is illustrated (see FIG. 2a). Here, the positioning bushing 4 is illustrated with the centrally arranged ultrasonic sensor 2. In an alternative embodiment, the ultrasonic sensor 2 could be arranged non-centrally. This is preferably the case when, for the ultrasonic signal 20, a reflection point 24 of the connection element 14 is not arranged centrally as considered in cross section, but, for example, is shifted relative thereto in the x-direction.

In FIG. 2b a ventilation opening 16 is illustrated. This can be formed, as shown in FIG. 1, as a hole in the positioning bushing 4. The ventilation opening 16 is preferably arranged level with the space produced in the region of the sensor head of the ultrasonic sensor 2 and the covered part of the connection element 14 during the measurement. The ventilation opening 16 is used to couple this space to the surrounding environment such that air can be conveyed. Alternatively, the ventilation opening 16 can be formed as a channel of specified size, which extends along the first recess 5a in the positioning bushing 4 and couples the space to the surrounding environment (see FIG. 2b).

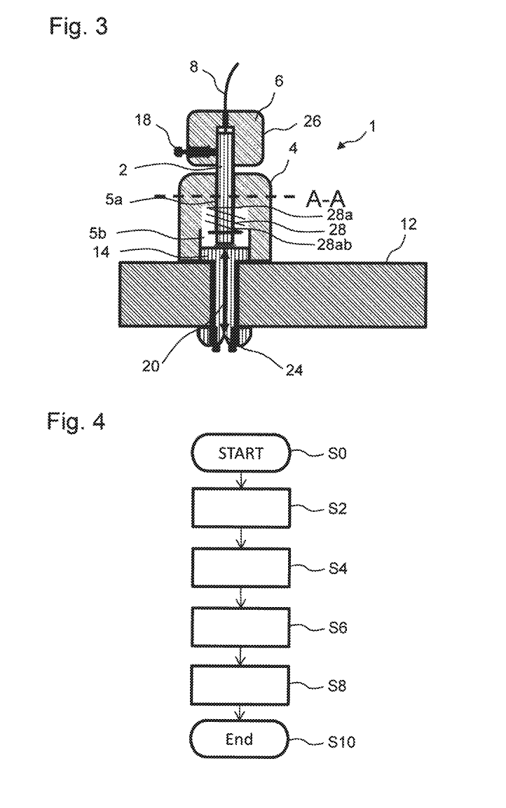

In FIG. 3 a further embodiment of the system 1 is illustrated. In comparison to FIG. 2a, the second recess 5b is formed here in such a way that it has a spring device 28. The spring device 28 is preferably formed as a compression spring, for example as a helical spring, in the second recess 5b. The spring device 28 is supported in the region of a first spring side 28a on the positioning bushing 4 and acts via a second spring side 28b on the sensor head of the ultrasonic sensor 2. For this purpose, the ultrasonic sensor 2 can have, in the region of the sensor head, a spring-receiving region secured to the sensor head. The ultrasonic sensor 2 is arranged in the first recess 5a of the positioning bushing 4 so as to be axially displaceable in the y-direction. Here, the spring device 28 has a compressive effect and thus acts on the ultrasonic sensor 2 in such a way that this is pushed in the direction of the connection element 14 during the measurement.

The first spring side 28a of the spring device 28 can be mechanically coupled to the positioning bushing 4, and the second spring side 28b can be mechanically coupled to the sensor head of the ultrasonic sensor 2, such that the ultrasonic sensor 2 cannot be lost as soon as the positioning bushing 4 is lifted from the surface 12. In addition, the guide bushing 6 can also be fixed to the ultrasonic sensor 2 in such a way that, as the spring device 28 acts on the ultrasonic sensor 2, the ultrasonic sensor cannot be pushed out from the first and second recess 5a, 5b. The guide bushing 6 is then in contact with the positioning bushing 4 and prevents a further axial displacement of the ultrasonic sensor 2 in the y-direction. Due to the corresponding fixing of the guide bushing 6 on the ultrasonic sensor 2, a maximum axial movement of the ultrasonic sensor 2 in the y-direction can thus be specified or limited.

In FIG. 4 a method sequence for measuring a connection element is illustrated. The method is started in a step S0.

In a further step S2, the connection element 14 is secured and is acted on by a specified preload, for example is fixedly screwed and/or riveted.

In a further step S4, the positioning bushing 4, with the ultrasonic sensor 2, is manually oriented relative to the connection element 14 to be measured. This can be implemented, for example, by the guide bushing 6 mechanically coupled to the ultrasonic sensor 2.

In a subsequent step S6, the second recess 5b of the positioning bushing 4 is placed over the protruding part of the connection element 14, more specifically in such a way that the positioning bushing 4 is in contact with the surface 12, from which the connection element 14 protrudes.

Alternatively, a specified coupling medium 22, for example a gel material, oil or water, can be applied, in step S6, to the protruding part of the connection element 14. The second recess 5b of the positioning bushing 4 is then placed over the protruding part of the connection element 14, more specifically in such a way that the positioning bushing 4 is in contact with the surface 12, from which the connection element 14 protrudes.

In a further step S8, the ultrasonic sensor 2 is displaced axially in the y-direction and/or is brought into contact with the connection element 14 to be measured. If the coupling medium 22 is used, the ultrasonic sensor 2 is brought into contact with the coupling medium 22. This can be implemented by holding the positioning bushing 4 on the surface 12 using one hand, while the ultrasonic sensor 3 is axially displaced and/or is held by means of the guide bushing 6 using the other hand

If the system has a spring device 28, the positioning bushing 4 can also be placed by hand over the connection element 14. In this case, the spring device 28 acts on the ultrasonic sensor 14 in such a way that this is pushed by means of the spring effect towards the connection element 14 to be measured and thus remains in contact therewith.

In a step S10, the connection element 14 is then measured. Here, it is ascertained whether the preload acting on the connection element 14 corresponds to a specified target preload.

In a step S12, the method is completed. For further measurements of connection elements, the method is started again with step S0.

The steps S4 to S8 do not necessarily have to be performed in the specified order. Alternatively, the second recess 5b in the positioning bushing 4 is placed over the protruding part of the connection element 14 in a step S2 or, more specifically, in such a way that the positioning bushing 4 is in contact with the surface 12, from which the connection element 14 protrudes. Here, the specified coupling medium 22 can still be applied beforehand to the protruding part of the connection element 14.

In a step S4, the positioning bushing 4, with the ultrasonic sensor 2, is oriented manually relative to the connection element 14 to be measured. This can be implemented, for example, by the guide bushing 6 mechanically coupled to the ultrasonic sensor 2.

In a step S6, the ultrasonic sensor 2 is displaced axially in the y-direction and/or is brought into contact with the connection element 14 to be measured. If the coupling medium 22 is used, the ultrasonic sensor 2 is brought into contact with the coupling medium 22. This can be implemented by holding the positioning bushing 4 on the surface 12 using one hand, while the ultrasonic sensor 3 is axially displaced or is held by means of the guide bushing 6 using the other hand

Whereas the invention has been illustrated and described in detail in the drawings and the above description, such illustrations and descriptions are intended to be merely illustrative or exemplary, and are not intended to be restrictive, such that the invention is not limited by the disclosed embodiments. In the claims, the word “comprising” does not rule out other elements, and the indefinite article “a” does not rule out a plurality. The fact that certain features are specified in different dependent claims does not limit the subject matter of the invention. Combinations of these features can also be used advantageously.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### LIST OF REFERENCE SIGNS

1 system

2 ultrasonic sensor

4 positioning bushing

5a, b sides of the positioning bushing

6 guide bushing

8 cables

12 surface

14 connection element

16 ventilation opening

18 fixing device

20 ultrasonic signal

22 coupling medium

24 reflection point

26 grip region

28 spring device

28a, b spring sides

A-A section through the positioning bushing

S0-S12 method steps

1. A system for taking a measurement at a connection element, which is already acted on by a preload and which protrudes from a specified surface, said system comprising:
an ultrasonic sensor, and
a positioning bushing, which has a first recess and a second recess, the first recess being configured to receive the ultrasonic sensor at least in part, the second recess being configured to receive at least part of the connection element protruding from the surface, the positioning bushing being configured to orientate the ultrasonic sensor relative to the connection element in a specified manner.

2. The system according to claim 1, in which the ultrasonic sensor is arranged in an axially displaceable manner in the first recess in the positioning bushing.

3. The system according to claim 1, in which the positioning bushing comprises at least one ventilation opening, which creates a connection between a space, which is formed during a measurement in the region of the sensor head of the ultrasonic sensor and the connection element, and a surrounding environment.

4. The system according to claim 1, which comprises a guide bushing, arranged separately from the positioning bushing and mechanically coupled to the ultrasonic sensor and having a grip region, by which the system can be manually guided.

5. The system according to claim 3, in which the guide bushing is arranged on an end of the ultrasonic sensor opposite the sensor head.

6. The system according to claim 3, in which the guide bushing is mechanically coupled to the ultrasonic sensor by a fixing device.

7. The system according to claim 1, in which the positioning bushing comprises at least one spring device, which acts on the ultrasonic sensor in a direction of the connection element during a measurement.

8. The system according to claim 1, in which the positioning bushing is made of a material that has a lower degree of hardness than a material from which the connection element to be measured is made.

9. The system according to claim 8, in which the positioning bushing is made of plastic.

10. A method for measuring a connection element by means of a system according to claim 1, comprising the steps:
securing the connection element and acting on the connection element with a preload,
orienting the ultrasonic sensor is oriented relative to the connection element and the surface by means of the second recess in the positioning bushing,
placing the second recess over the protruding part of the connection element, measuring the connection element.

11. The method according to claim 5, in which the system is manually oriented relative to the connection element and the surface by means of the second recess in the positioning bushing, and the connection element is then measured.
